(19) United States
(12) Patent Application Publication
(10) Pub. No.: US 2012/0145489 A1
(43) Pub. Date: Jun. 14, 2012

(54) MACHINE-ROOM-LESS ELEVATOR SYSTEM AND METHOD THEREOF

(76) Inventors: Wei Tian, Jiangsu (CN); Ashur William Kanon, Folsom, CA (US)

(21) Appl. No.: 13/378,148

(22) PCT Filed: Jun. 16, 2010
(86) PCT No.: PCT/US10/38843

§ 371 Date: Feb. 24, 2012

Related U.S. Application Data
(60) Provisional application No. 61/187,530, filed on Jun. 16, 2009.

(51) Int. Cl. B66B 11/00

(52) U.S. Cl. 187/406

(57) ABSTRACT

The present general inventive concept provides an elevator system and method that provides minimal vibration during use thereof, simplified installation and maintenance, and a machine to power the system supported by a machine-support structure mounted between counterweight guide rails.

### CROSS-REFERENCE TO RELATED APPLICATION

This application claims the priority of earlier filed United States Provisional Application Ser. No. 61/187,530, filed Jun. 16, 2009, the disclosures of which are hereby incorporated herein by reference in their entirety to the extent permitted by law.

### BACKGROUND OF THE INVENTION

1. Field of the Invention

The present general inventive concept relates to an elevator system and method, and more particularly to a traction elevator system and method that provides minimal vibration during use thereof, and simplified installation and maintenance.

2. Description of the Related Art

Conventional elevators operate using a hydraulic system with an engine housed in a machine room. Conventional engines are large, difficult to install and maintain, and provide an inefficient power transfer thereby causing excessive vibrations and consuming an excessive amount of energy during operation thereof.

Accordingly, there is a demand for an elevator system and method that provides minimal vibration during operation thereof and simplified installation and maintenance.

### SUMMARY OF THE INVENTION

The present general inventive concept provides an elevator system and method that provides minimal vibration during use thereof.

The present general inventive concept provides an elevator system and method that provides simplified installation and maintenance.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing an elevator system including a magnet, a traction machine to power the elevator system, the machine having a power source, a counterweight supported by counterweight guide rails, wherein the machine is supported by a machine-support structure mounted between the counterweight guide rails.

The magnet may be permanent.

The machine may be gearless.

The machine may be synchronous.

The machine may have an external rotor.

The power source may be an alternating current.

The machine-support structure may have a cassette structure, a cassette substructure, or a cassette-like substructure.

The elevator system may not powered by hydraulics.

The present general inventive concept may also include a bedplate to support the traction machine with an isolation pad therebetween.

The foregoing and/or other aspects and utilities of the present general inventive concept may also be achieved by providing an elevator method, the method including providing a magnet, powering the machine-room-less elevator system via a traction machine, the machine having a power source, supporting a counterweight via counterweight guide rails, and supported the machine-support structure between the counterweight guide rails.

The foregoing and other objects are intended to be illustrative of the present general inventive concept and are not meant in a limiting sense. Many possible embodiments of the present general inventive concept may be made and will be readily evident upon a study of the following specification and accompanying drawings comprising a part thereof. Various features and subcombinations of present general inventive concept may be employed without reference to other features and subcombinations. Other objects and advantages of this present general inventive concept will become apparent from the following description taken in connection with the accompanying drawings, wherein is set forth by way of illustration and example, an embodiment of this present general inventive concept.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a schematic view illustrating an exemplary embodiment of the present general inventive concept.

FIG. 2 is a photograph illustrating an exemplary embodiment of the present general inventive concept with a base beam bolted to support hangers.

FIG. 3 is a photograph illustrating an exemplary embodiment of the present general inventive concept with a traction machine supported by a bedplate with an isolation pad therebetween.

FIG. 4 is a photograph illustrating an exemplary embodiment of the present general inventive concept with support hangers fixedly attached to counter-weight rails by heavy-duty bolts.

FIG. 5 is a perspective view illustrating a hoistway layout of an exemplary embodiment of the present general inventive concept.

FIG. 6 is a top plan view illustrating a hoistway layout of an exemplary embodiment of the present general inventive concept.

FIG. 7 is a front plan view illustrating a traction system of an exemplary embodiment of the present general inventive concept.

FIG. 8 is a side plan view illustrating a traction system of an exemplary embodiment of the present general inventive concept.

FIG. 9 is a top plan view illustrating a traction system of an exemplary embodiment of the present general inventive concept.

### DETAILED DESCRIPTION OF THE INVENTION

The present general inventive concept provides an elevator system and method that provides minimal vibration during use thereof.

The MRL elevator system utilizes a permanent magnet, AC, synchronous, gearless traction machine with an external rotor.

The traction machine is mounted between the two counterweight (CTW) guide rails using a special cassette-like sub-structure.

The traction machine is located at either the left or the right side of the shaft behind the elevator cabin.

The MRL elevator system may have 2:1 roping thereby providing a capacity, i.e., is able to raise and/or lower a car within a shaft of the MRL elevator system having a weight, ranging from 320 kg to 2000 kg. If the MRL elevator system has 4:1 roping, the capacity ranges from 2000 Kg to 3500 kg.

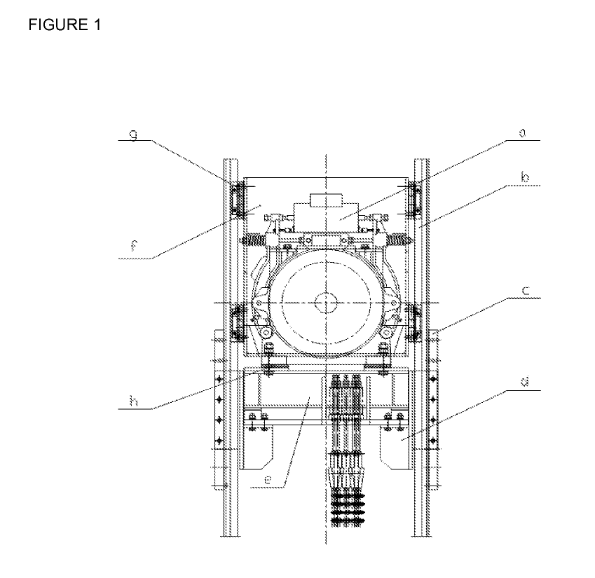

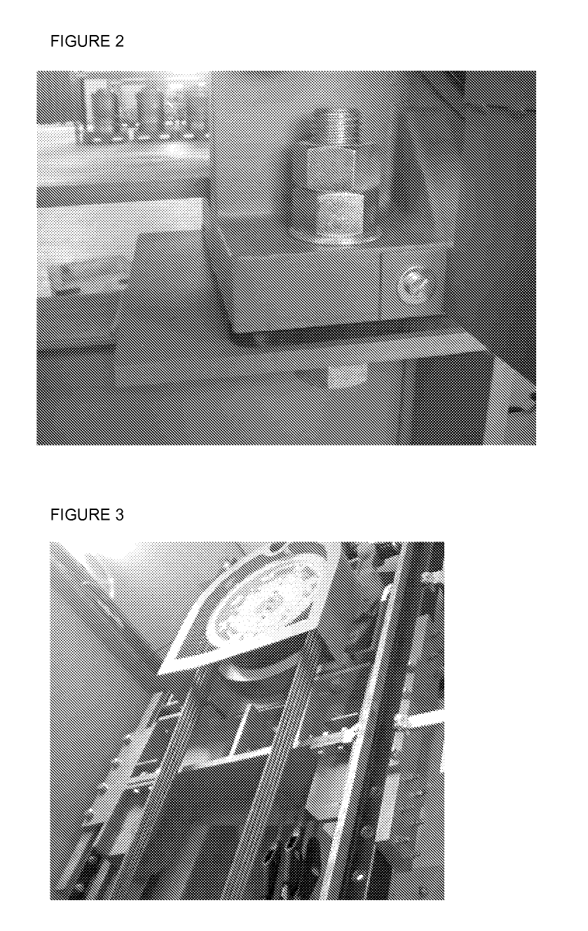

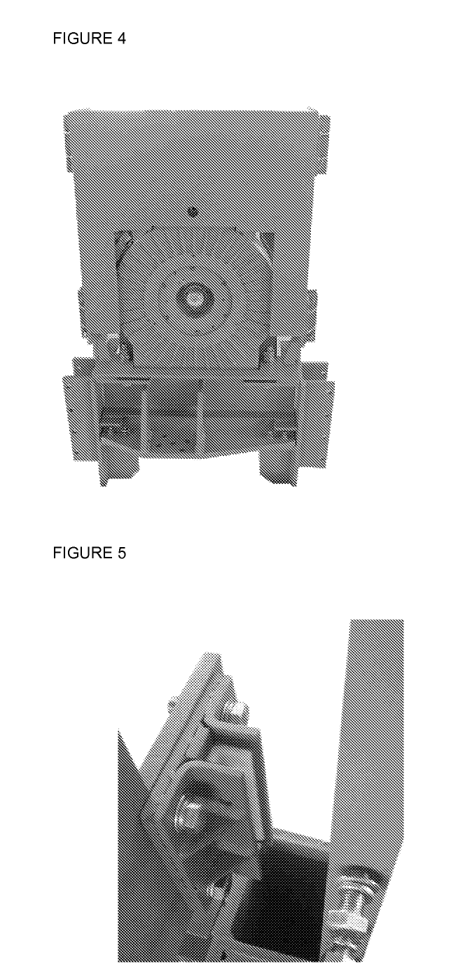

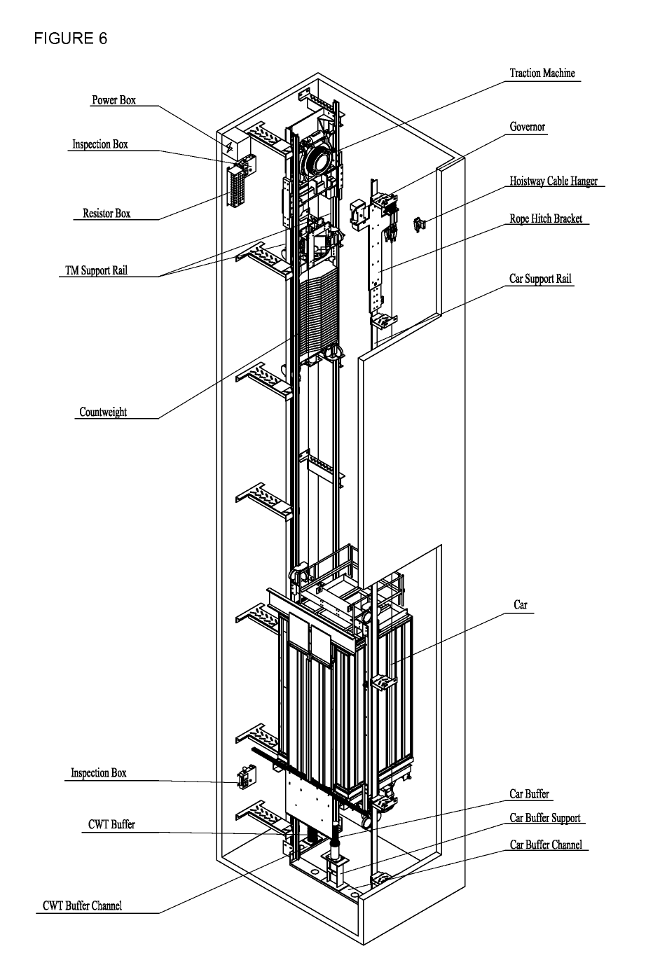

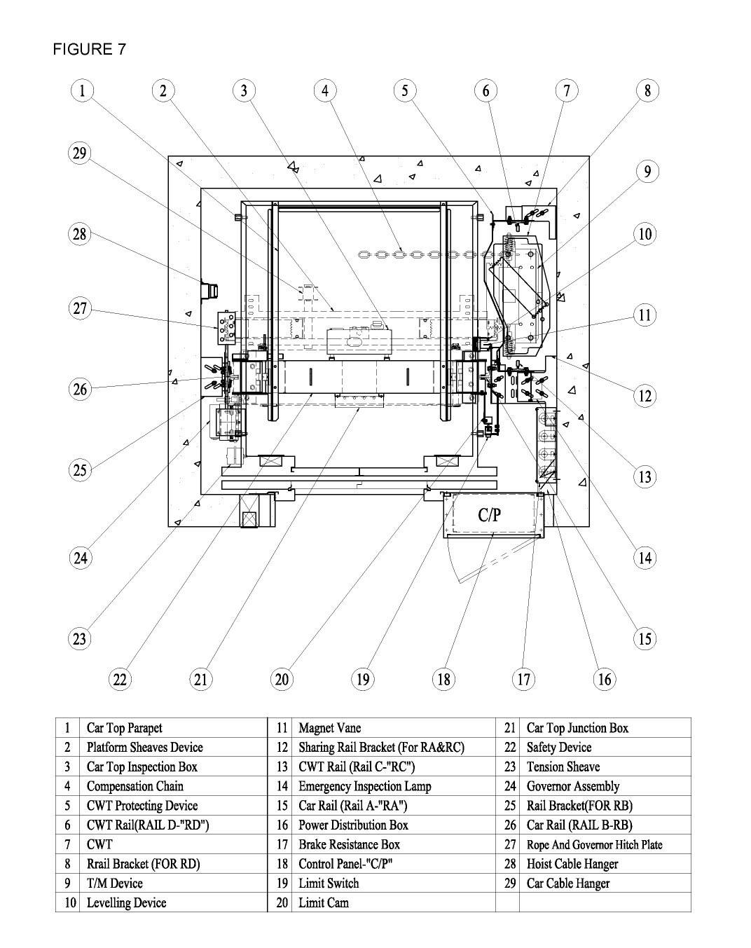

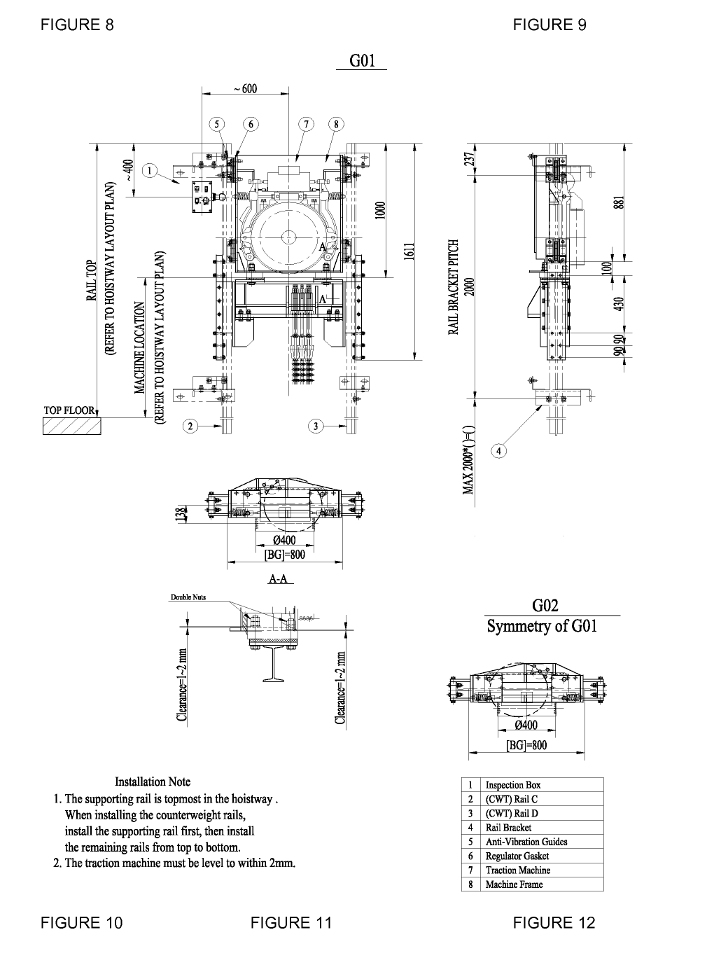

Referring to FIG. 1, the system includes ‘a’: Traction machine, ‘b’: Counter-weight Guide Rail, ‘c’: Supporting Hanger, ‘d’: Supporting Base Beam, ‘e’: Machine Bedplate, ‘f’: Upper Machine Frame, ‘g’: Supporting Nylon Guide Shoe, and ‘h’: Isolation pad.

The traction machine ‘a’ is sitting on the machine bedplate ‘e’ with isolation pads ‘h’ in between; The isolation pads reduce vibration and noise transmission from the machine to the rails, in turn reducing vibration and noise transmission ambiently and/or through the pit floor to the structure of the building. This results in a quieter elevator ride and/or a quieter building.

The machine bedplate ‘e’ is connected to the support base beam ‘d’;

Support base beam ‘d’ is in turn bolted to the supporting hangers ‘c’;

The entire bedplate/support beam/hanger structure is extremely robust.

The supporting hangers ‘c’ are fixed to the counter-weight guide rails ‘b’ by heavy-duty bolts;

Above the bedplate/support beam/hanger structure, the upper machine frame ‘f’ of the traction machine ‘a’ is additionally fixed to the guide rails by four, unique, guide shoes ‘g’.

Each guide shoe has a nylon composite inner liner. Together the guide shoes provide at least the following advantages:

1. Longitudinal alignment with the guide rails, offsetting any front-to-back weight or force transfer differentials.

2. Additional vibration and noise transfer reduction.

3. Hoist guidance: During initial installation and to facilitate future rope or machine repair, the machine can be de-coupled from the base structure and moved up or down between the guide rails.

The unique mounting of the traction machine between the counterweight guide rails, with the alignment and dampening provided by the supporting nylon guide shoes, allows the traction machine very slight movement along the vertical axis. Together with the rubber isolation pads, these features provide dampening and absorption of machine-generated vibration. In addition, the cassette-like machine support structure can be de-coupled from the base structure to slide along the counterweight guide rails for easier and safer installation and service.

The foregoing description of the embodiments of the invention has been presented for purposes of illustration and description, and is not intended to be exhaustive or to limit the invention to the precise form disclosed. The description was selected to best explain the principles of the invention and practical application of these principles in order to enable others skilled in the art to best utilize the invention in various embodiments and with such modifications as are suited to the particular use contemplated. It is intended that the scope of the invention not be limited by the specification, but be defined by the claims as set forth below.

What is claimed is:

1. An elevator system, the system comprising:
a magnet;
a traction machine to power the elevator system, the machine having a power source;
a counterweight supported by counterweight guide rails,
wherein the machine is supported by a machine-support structure mounted between the counterweight guide rails.

2. The system according to claim 1, wherein the magnet is permanent.

3. The system according to claim 1, wherein the machine is gearless.

4. The system according to claim 1, wherein the machine is synchronous.

5. The system according to claim 1, wherein the machine has an external rotor.

6. The system according to claim 1, wherein the power source is an alternating current.

7. The system according to claim 1, wherein the machine-support structure is a cassette-like substructure.

8. The system according to claim 1, wherein the elevator system is not powered by hydraulics.

9. The system according to claim 1, further comprising:
a bedplate to support the traction machine with an isolation pad therebetween.

10. An elevator method, the method comprising:
providing a magnet;
powering the elevator system via a traction machine, the machine having a power source;
supporting a counterweight via counterweight guide rails; and
supported the machine-support structure between the counterweight guide rails.

11. The system according to claim 1, wherein the machine is housed outside of a machine room.
